(19) United States
(12) Patent Application Publication
(10) Pub. No.: US 2010/0255824 A1
(43) Pub. Date: Oct. 7, 2010

(54) COMMUNICATION SYSTEM PROVIDING LOCAL TIME OF LONG DISTANCE MOBILE TERMINALS AND METHOD THEREOF

(75) Inventors: YUNG-HO SHIH, Bellevue, WA (US); CHING-CHIH SHIH, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/616,199

(22) Filed: Nov. 11, 2009

(30) Foreign Application Priority Data
Apr. 2, 2009 (CN) 200910301295.5

(51) Int. Cl. H04M 3/42; H04W 40/00; H04W 64/00

(52) U.S. Cl. 455/414.1; 455/422.1; 455/456.1

(57) ABSTRACT

A communication system providing local time of long distance mobile terminals and a method thereof are disclosed. The communication system includes a Network Switching Subsystem (NSS), a local mobile terminal and a long distance mobile terminal connected to the NSS, an Internet network, and a database respectively connected to the NSS and the Internet network. The local mobile terminal downloads time zone information of the long distance mobile terminal from the database by connecting to the NSS or the Internet work so as to determine local time of the long distance mobile terminal based on the time zone information.

### BACKGROUND

1. Technical Field

The present disclosure relates to a communication system providing local time of long distance mobile terminals and a method thereof.

2. Description of Related Art

When making a long distance telephone call to a person (the called party) located in a time zone that is different from that associated with the person making the call (the calling party), it is polite to know current local time of the called party and whether it is appropriate time to call the called party, before making the call.

It is not always easy to determine the local time of a person receiving the long distance telephone call. For example, the calling party might not know the time difference between a local time of the calling party and the local time of the called party, thus unable to determine the local time of the called party. Even if the user is aware of the time difference, it is often awkward to determine the local time of a person receiving the long distance telephone call. Thus, a system and method to alleviate such problems is needed.

### BRIEF DESCRIPTION OF THE DRAWINGS

FIG. 1 is a block diagram of one embodiment of a communication system providing local time of long distance mobile terminals.

FIG. 2 is a flowchart illustrating one embodiment of establishing time zone information in the communication system of FIG. 1.

FIG. 3 is a flowchart illustrating another embodiment of establishing time zone information in the communication system.

FIG. 4 is a flowchart illustrating one embodiment of determining local time of a long distance mobile terminal.

### DETAILED DESCRIPTION

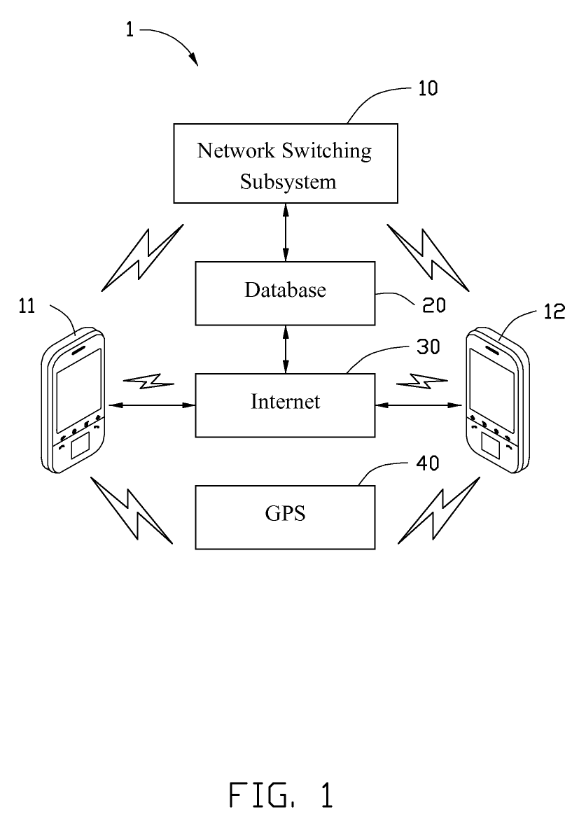

FIG. 1 is a block diagram of one embodiment of a communication system 1 capable of providing the local time of one or more long distance mobile terminals. The communication system 1 includes a Network Switching Subsystem (NSS) 10, a local mobile terminal 11 and a long distance mobile terminal 12 connected to the NSS 10, an Internet network 30, a database 20 respectively connected to the NSS 10 and the Internet network 30, and a Global Positioning System (GPS) 40. The local mobile terminal 11 downloads time zone information of the long distance mobile terminal 12 from the database 20 by connecting to the NSS 10 or the Internet work 30 so as to determine local time of the long distance mobile terminal 12 based on the time zone information.

In one embodiment, the time zone information is converted from a Location Area ID of the long distance mobile terminal 12 by the long distance mobile terminal 12. In another embodiment, the time zone information is converted from the Location Area ID of the long distance mobile terminal 12 by the NSS 10. In an alternative embodiment, the time zone information is acquired from the GPS 40.

The time zone information includes the locations of the mobile terminals, coordinates of the locations, and time difference between the local time and Coordinated Universal Time (UTC). The time difference may be expressed as “UTC+/−x”, for example, UTC+8, UTC−5, etc. The local mobile terminal 11 determines the local time of the long distance mobile terminal 12 based on the time difference in the time zone information and the current UTC.

The communication system 1 may utilize GSM technology enhanced with GPRS. However, the other telecommunication standards may be employed, such as FDMA, TDMA, CDMA, CDMA 2000, UTMS, or EDGE, without departing from the spirit of the disclosure.

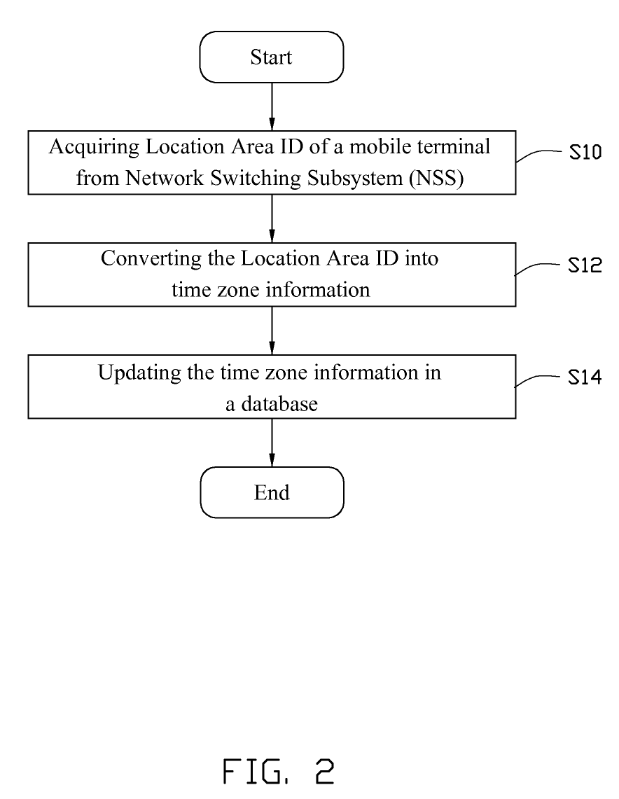

FIG. 2 is a flowchart illustrating one embodiment of a method for establishing time zone information in the communication system 1. Additional blocks may be added, others removed, and the ordering of the blocks may be changed.

In block S10, the long distance mobile terminal 12 acquires Location Area ID of the long distance mobile terminal 12 from the NSS 10. In block S12, the long distance mobile terminal 12 converts the Location Area ID into the time zone information.

In block S14, the long distance mobile terminal 12 updates the time zone information in the database 20.

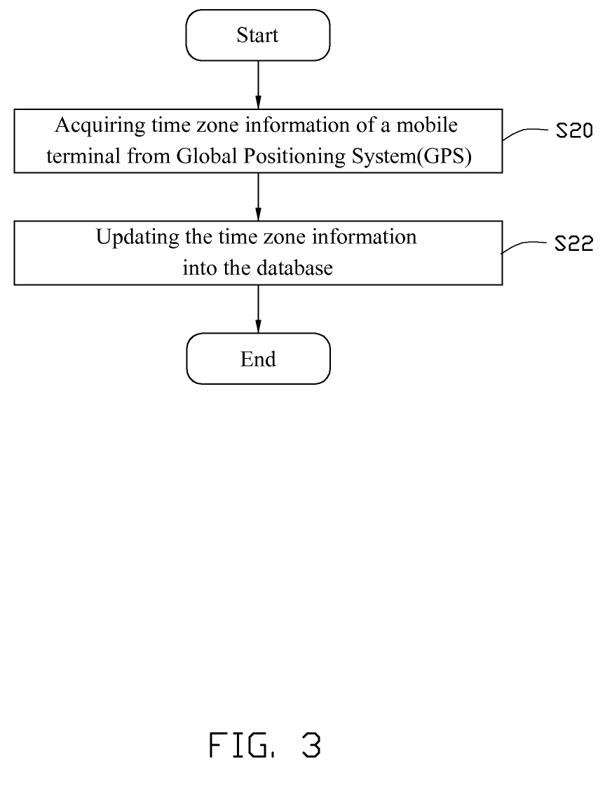

FIG. 3 is a flowchart illustrating another embodiment of establishing time zone information in the communication system 1. Additional blocks may be added, others removed, and the ordering of the blocks may be changed.

In block S20, the long distance mobile terminal 12 acquires the time zone information from the GPS 40.

In block S22, the long distance mobile terminal 12 updates the time zone information in the database 20.

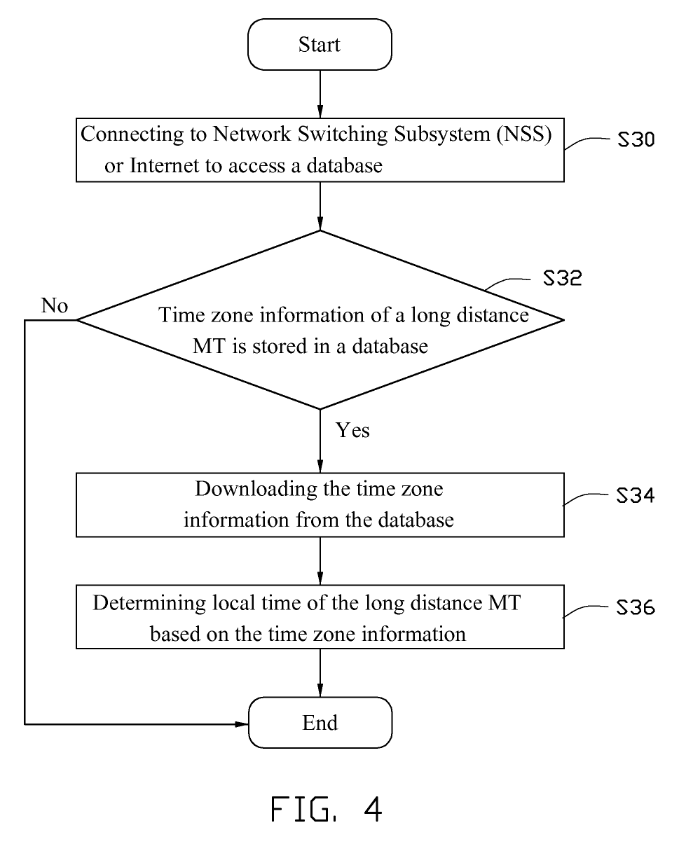

FIG. 4 is a flowchart illustrating one embodiment of determining local time of a long distance mobile terminal Additional blocks may be added, others removed, and the ordering of the blocks may be changed.

In block S30, the local mobile terminal 11 accesses the database 20 by connecting to the NSS 10 or the Internet network 30.

In block S32, the local mobile terminal 11 determines whether the time zone information of the long distance mobile terminal 12 is stored in the database 20. If the time zone information is not stored in the database 20, the process is complete.

In block S34, if the time zone information is stored in the database 20, the local mobile terminal 11 downloads the time zone information.

In block S36, the local mobile terminal 11 determines the local time of the long distance mobile terminal 12 based on the time zone information.

The present disclosure provides a convenient way to determine, prior to initiating a call, the local time at the long distance whenever the user wishes to make a call.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication system comprising:
a database connected to a Network Switching Subsystem (NSS) to store time zone information of locations of at least a first mobile terminal and a second mobile terminal;
wherein the first mobile terminal downloads the time zone information of a current location of the second mobile terminal from the database by connecting to the NSS, so as to determine a local time of the second mobile terminal based on the time zone information.

2. The communication system of claim 1, wherein the time zone information is converted from a Location Area ID of the second mobile terminal.

3. The communication system of claim 1, wherein the time zone information is acquired from a Global Positioning System (GPS).

4. The communication system of claim 1, wherein the database is further connected to an Internet network.

5. The communication system of claim 4, wherein the first mobile terminal downloads the time zone information from the database by connecting to the Internet network so as to determine the local time of the second mobile terminal based on the time zone information.

6. A computer-implemented method for establishing time zone information of a location of a mobile terminal, the method comprising:
acquiring the time zone information of the mobile terminal from a Network Switching Subsystem (NSS) or a Global Positioning System (GPS); and
updating the time zone information in a database connected to the NSS.

7. The method of claim 6, wherein the step of acquiring the time zone information of the mobile terminal from the NSS further comprises:
acquiring a Location Area ID of the mobile terminal from the NSS; and
converting the Location Area ID of the mobile terminal into the time zone information of the location of the mobile terminal

8. A computer-implemented method for determining local time of a long distance mobile terminal, the method comprising:
determining whether time zone information of the long distance mobile terminal is stored in a database connected to a Network Switching Subsystem (NSS);
downloading the time zone information from the database if the time zone information is stored in the database; and
determining the local time of the long distance mobile terminal based on the time zone information.

9. The method of claim 8, wherein the database further connects to an Internet network, the method further comprising:
determining whether the time zone information of the long distance mobile terminal is stored in the database by connecting to the Internet network; and
downloading the time zone information from the database by connecting to the internet network if the time zone information is stored in the database.
